(19) United States
(12) Patent Application Publication
(10) Pub. No.: US 2008/0055537 A1
(43) Pub. Date: Mar. 6, 2008

(54) SYSTEM FOR TRANSRECEIVING ELECTROMAGNETIC SIGNALS IN A COMMUNICATION NETWORK

(75) Inventors: VIJAY L. ASRANI, ROUND LAKE, IL (US); ADRIAN NAPOLES, LAKE VILLA, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/468,797

(22) Filed: Aug. 31, 2006

(51) Int. Cl. G02C 5/00

(52) U.S. Cl. 351/41

(57) ABSTRACT

An apparatus (200) is provided. The apparatus includes a first eyeglass frame section (204). Further, the apparatus includes a first antenna embedded in the first eyeglass frame section. Furthermore, the apparatus includes a second eyeglass frame section (206). Moreover, the apparatus includes a second antenna embedded in the second eyeglass frame section.

### FIELD OF INVENTION

The present invention generally relates to antennas, and more specifically, to an apparatus for reducing electromagnetic signal fading in antennas.

### BACKGROUND

Presently, an antenna is an apparatus that transreceives electromagnetic signals. Electromagnetic signals are waves or signals generated by varying electric and magnetic fields. Examples of electromagnetic signals include radio signals, microwaves, Frequency Modulated (FM) signals, X-rays, Gamma rays, Amplitude-modulated (AM) signals, etc. Electromagnetic signals are interpreted by devices in order to identify data or information contained in the signals. Examples of devices that can interpret electromagnetic signals include televisions, radios, computers, displays, speakers, cellular phones, etc.

An important use of antennas is in mobile communications. Devices used for mobile communications can be cellular phones, satellite phones, Bluetooth devices, personal digital assistants (PDAs), etc. Significant developments in the field of mobile communication devices have enabled uninterrupted and efficient communication between two or more remote devices. Further, several devices enable hands-free operation on cellular, cordless and satellite phones. Moreover, there are numerous situations where it is convenient and preferable to mount the audio or video input/output (I/O) of the devices on the user's head. Such devices can be worn on the head or can be integrated in the eyewear of the user. The devices can be used for entertainment, communication, etc. For example, these devices can be used in conjunction with cellular and cordless phones, radios, tape players, MP3 players, portable video systems, and hand-held and laptop computers. Communication can be made wireless in these devices, with the help of antennas.

To improve mobility, attempts have been made to integrate a mobile communication device, a display, and an antenna in eyewear. This not only enables hands-free operation but also allows the user to have access to audio and visual information while on the move. The mobile communication device can provide information that is already stored in it, or can receive information as electromagnetic signals through antennas connected to the device. Examples of such applications can be the Internet, television, GPS, Bluetooth, DVB-H, WiFi, XM radio, etc. Current mobile communication devices incorporate a Bluetooth transreceiving device mounted on the eyewear. The user's hands are free, and he/she can access the wireless operation of the Bluetooth transreceiving device while on the move. However, the Bluetooth transreceiving device does not support a multiple application operation and is a separate module mounted on the eyewear. As a separate module there would be the high probability of the device getting damaged easily.

Further, mobile communication devices suffer from the problem of electromagnetic signal fading, which is the result of geographic constraints, the effect of interference, system limitations, etc. Electromagnetic signal fading results in inefficient transmission of electromagnetic signals, noise, etc. Therefore, there is a need for a data-processing unit, which can improve flexibility in mobile communication without compromising on electromagnetic signal quality. Moreover, a single integrated mobile communication device can eliminate the inconvenience caused by handling too many modules simultaneously.

### BRIEF DESCRIPTION OF FIGURES

The preferred embodiments of the invention will hereinafter be described in conjunction with the appended drawings, provided to illustrate and not to limit the disclosure, wherein like designations denote like elements, and in which:

FIG. 1 is a functional diagram illustrating a communication network, in accordance with some embodiments of the present disclosure;

FIG. 2 illustrates a functional diagram of an eyewear, in accordance with some embodiments of the present disclosure;

FIG. 3 illustrates a functional diagram of the eyewear, describing the functioning of the eyewear, in accordance with an embodiment of the present disclosure;

FIG. 4 is a functional diagram illustrating the operation of the eyewear, in accordance with some embodiments of the present disclosure; and

FIG. 5 illustrates a functional diagram of an eyewear, in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of embodiments of the present invention.

### SUMMARY

An apparatus is provided, in accordance with various embodiments of the present disclosure. The apparatus includes a first eyeglass frame section. Further, the apparatus includes a first antenna embedded in the first eyeglass frame section. Furthermore, the apparatus includes a second eyeglass frame section, as well as a second antenna embedded in the second eyeglass frame section.

An apparatus for transreceiving electromagnetic signals is provided, in accordance with the present disclosure. The apparatus includes an eyeglass frame section. Further, the apparatus includes a first antenna embedded in the eyeglass frame section, for transreceiving electromagnetic signals. Furthermore, the apparatus includes a bridge coupled to the eyeglass frame section, as well as a second antenna embedded in the eyeglass frame section, for transreceiving electromagnetic signals.

An apparatus for diversity is provided, in accordance with the present disclosure. The apparatus includes a first eyeglass frame section. Further, the apparatus includes a first antenna embedded in the first eyeglass frame section. Furthermore, the apparatus includes a second eyeglass frame section and a second antenna embedded in the second eyeglass frame section, as well as a bridge coupled to the first eyeglass frame section and the second eyeglass frame section. Moreover, the bridge comprises an isolator for diversity between the first and second antennas.

### DESCRIPTION OF PREFERRED EMBODIMENTS

Before describing in detail the particular system for transreceiving electromagnetic signals in a communication network, in accordance with various embodiments of the present invention, it should be observed that the present invention resides primarily in combinations of systems for transreceiving electromagnetic signals in a communication network. Accordingly, the apparatus components have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises”, “comprising” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another”, as used in this document, is defined as at least a second or more. The terms “includes” and/or “having”, as used herein, are defined as comprising.

A “set”, as used in this document, means a non-empty set, i.e., comprising at least one member. The term “another”, as used herein, is defined as at least a second or more. The term “including”, as used herein, is defined as comprising.

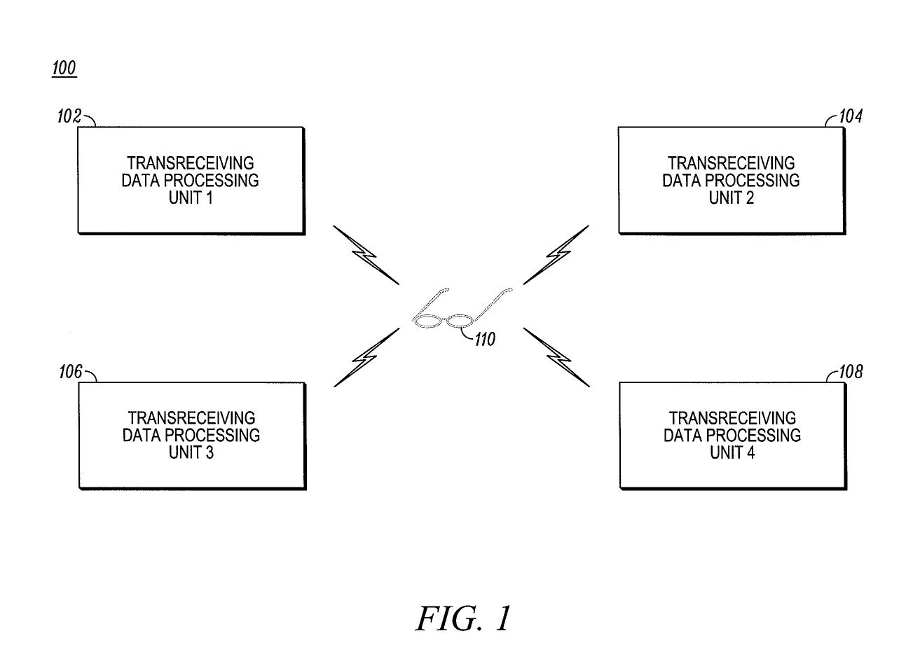

FIG. 1 is a functional diagram illustrating a communication network 100, in accordance with some embodiments of the present disclosure. The present disclosure aims at enabling a user to communicate while the user is mobile. The communication network 100 can be used to exchange data or information among different data-processing units. For example, the user of a first data-processing unit can access an application, a database or a peripheral data-processing unit that is stored at a second data processing unit. Examples of the communication network 100 include a local area network (LAN), a wide area network (WAN), a wireless local area network (WLAN), a general packet radio service (GPRS) network, a telecommunications network, and the Internet. The communication network 100 includes a plurality of transreceiving data-processing units such as transreceiving data-processing unit 102, transreceiving data-processing unit 104, transreceiving data-processing unit 106, and transreceiving data-processing unit 108. Further, the communication network 100 includes a remote data-processing unit 110 mounted on an eyewear. The transreceiving data-processing units 102, 104, 106 and 108 transmit and receive electromagnetic signals to and from the remote data-processing unit 110. Examples of transreceiving data-processing unit 102 can be a base transreceiver station (BTS), a television relay station, a Wi-Fi data-processing unit, a Bluetooth device, a digital video-broadcasting (DVB) data-processing unit, a global positioning system (GPS), etc. Examples of a remote data-processing unit 110 can be a Bluetooth transreceiver, a Wi-Fi receiver, etc.

The remote data-processing unit 110 processes electromagnetic signals and relays back the processed electromagnetic signals to the transreceiving data-processing units 102, 104, 106 and 108. To increase flexibility and simplicity, the remote data-processing unit 110 is mounted on the eyewear. Further, the remote data-processing unit 110 can be a Bluetooth device and can transreceive electromagnetic signals from any of the transreceiving data-processing units 102, 104, 106 and 108. Furthermore, the remote data-processing unit 110 includes an antenna to transreceive electromagnetic signals sent by the transreceiving data-processing units 102, 104, 106 and 108. The antenna is connected to an internal circuitry of the remote data-processing unit 110, which processes the electromagnetic signal and retrieves useful information and data.

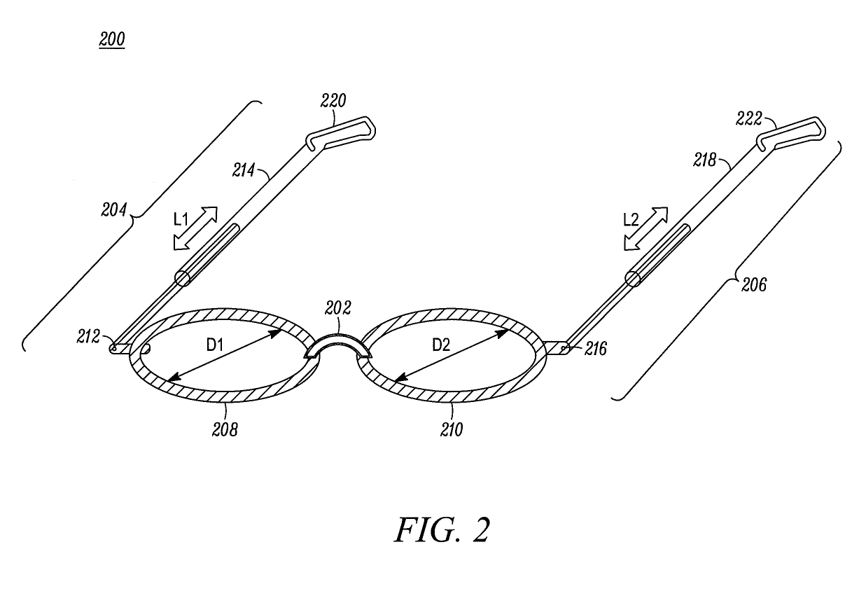

FIG. 2 illustrates a functional diagram of an eyewear 200, in accordance with some embodiments of the present disclosure. The eyewear 200 includes an isolation bridge 202, coupled with a first antenna pair 204 and a second antenna pair 206. The first antenna pair 204 includes adjustable antenna frames 212 and 214 with an eyepiece holder 208. The second antenna pair 206 includes adjustable antenna frames 216 and 218 with an eyepiece holder 210. The first antenna pair 204 and the second antenna pair 206 may include multiple combinations of the adjustable antenna frames 212, 214, 216 and 218 with the eyepiece holders 208 and 210. The isolation bridge 202 couples the eyepiece holders 208 and 210. Further, the isolation bridge 202 provides electromagnetic and physical isolation between the first antenna pair 204 and the second antenna pair 206. Moreover, the eyepiece holders 208 and 210 can have adjustable diameters D1 and D2, which provide flexibility to the user to have eyepiece holders 208 and 210 of different shapes. Furthermore, the eyepiece holders 208 and 210 act as separate antennas, in conjunction with the adjustable antenna frames 212, 214, 216 and 218. For another embodiment, the eyepiece holders 208 and 210 can be segmented to receive electromagnetic signals of different frequencies. Further, the eyepiece holders 208 and 210 can have multiple segments for receiving a range of electromagnetic signals of multiple frequencies, for example, radio waves, microwaves, amplitude modulation (AM), frequency modulation (FM), etc.

For an embodiment of the present disclosure, the adjustable antenna frames 212, 214, 216 and 218 can be metallic. For another embodiment of the present invention, the antenna frames 212 and 216 can be metallic and the antenna frames 214 and 218 can be of any other material. Further, the eyepiece holders 208 and 210 can be of various shapes such as oval, rectangular, polygon with adjustable dimensions, etc. The adjustable dimensions of antenna pairs enable the eyewear 200 to receive electromagnetic signals of multiple frequencies.

Further, the eyewear 200 includes integrated circuitries 220 and 222, which are integrated with the adjustable antenna frames 214 and 218, respectively. For another embodiment, the integrated circuitry 220 and 222 can be coupled with the first antenna pair 204 and the second antenna pair 206. Each of the integrated circuitry 220 and 222 may also include a power module to provide power to various system elements of the present disclosure. The integrated circuitry 220 and 222 can be powered by single-power or multi-power modules, as well as by conventional or non-conventional power sources. Furthermore, the integrated circuitries 220 and 222 may include a transreceiving module, which can enable transreceiving of electromagnetic signals through the first antenna pair 204 and the second antenna pair 206. Moreover, the integrated circuitry 220 and 222 can incorporate an interface to interpret the electromagnetic signals into data and information.

For an embodiment, the adjustable antenna frames 212 and 214 can be concentric metallic cylinders or concentric bars. The adjustable antenna frame 214 can slide over the adjustable antenna frame 212 to vary a length L1 of the first antenna pair 204. Furthermore, the adjustable antenna frames 216 and 218 can be concentric metallic cylinders or concentric bars. Moreover, the adjustable antenna frame 218 can slide over the adjustable antenna frame 216 to vary a length L2 of the second antenna pair 206. Variable lengths L1 and L2, with variable diameters D1 and D2, provide flexibility in the operation of the first antenna pair 204 and the second antenna pair 206, to receive electromagnetic signals of multiple frequencies. Further, a user of the eyewear 200 can tune the first antenna pair 204 and the second antenna pair 206 by varying the lengths L1 and L2 with the diameters D1 and D2, to transreceive electromagnetic signals of multiple frequencies. For another embodiment, the eyewear 200 can include a single first antenna pair 204 and a second fixed length antenna pair 206. The antenna pairs 204 and 206 can be isolated by the isolation bridge 202.

For another embodiment, the eyewear 200 can include a first frame temple in place of the adjustable antenna frames 212 and 214. The eyewear 200 can include a first eyepiece in place of the eyepiece holder 208. Further, the first frame temple can be coupled to the first eyepiece. Furthermore, the isolation bridge 202 is coupled to the first eyepiece. The eyewear 200 can include a second frame temple in place of the adjustable antenna frames 216 and 218. The eyewear 200 can also include a second eyepiece in place of the eyepiece holder 210. Further, the second frame temple can be coupled to the second eyepiece. Furthermore, the second eyepiece is coupled substantially to the other side of the isolation bridge 202.

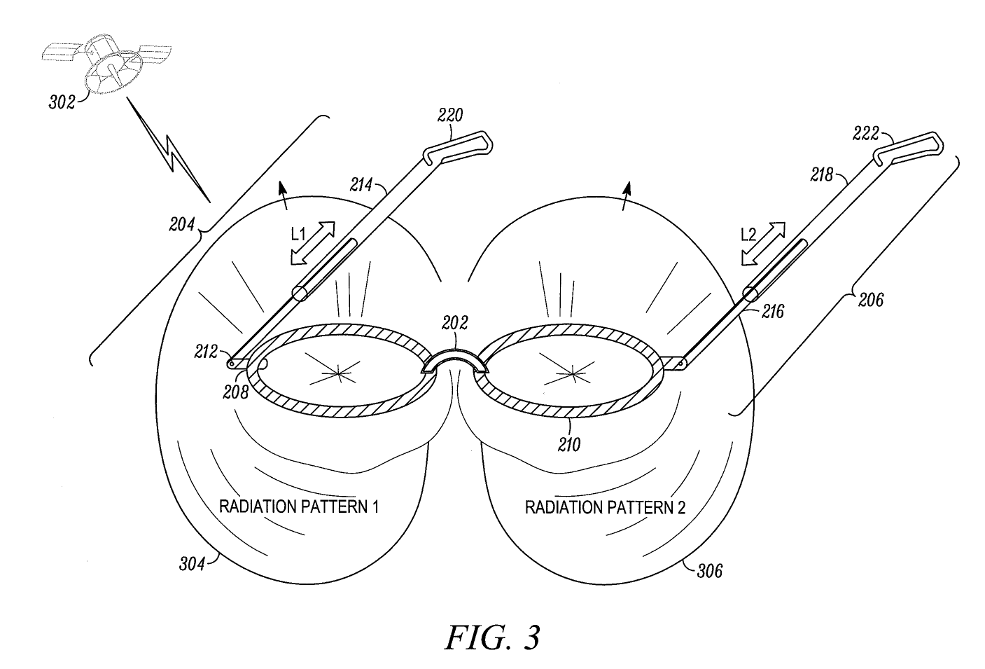

FIG. 3 illustrates a functional diagram describing the functioning of the eyewear 200, in accordance with an embodiment. The present disclosure includes the eyewear 200. The eyewear 200 includes the isolation bridge 202, which provides electromagnetic isolation between the first antenna pair 204 and the second antenna pair 206. The first antenna pair 204 is formed by the eyepiece holder 208 with the adjustable antenna frames 212 and 214. The integrated circuitry 220 controls the first antenna pair 204 for transreceiving electromagnetic signals. The second antenna pair 206 is formed by the eyepiece holder 210 with the adjustable antenna frames 216 and 218. The integrated circuitry 222 controls the second antenna pair 206 for transreceiving the electromagnetic signals. Further, the communication network 100 includes an artificial satellite 302 for transreceiving the electromagnetic signals with the eyewear 200. The eyewear 200 communicates with the artificial satellite 302 through the first antenna pair 204 and the second antenna pair 206.

The first antenna pair 204 produces a first radiation pattern 304 and the second antenna pair 206 produces a second radiation pattern 306. The first radiation pattern 304 includes variations of the field intensity of the first antenna pair 204. The second radiation pattern 306 includes variations of the field intensity of the second antenna pair 206. Further, the first radiation pattern 304 and the second radiation pattern 306 include a graphical depiction of the relative field strength transmitted from or received by the first antenna pair 204 and the second antenna pair 206, respectively. The first radiation pattern 304 and the second radiation pattern 306 are represented graphically for far-field conditions along the electrical field and magnetic field vectors, in the direction of maximum radiation. For an embodiment, the first radiation pattern 304 and the second radiation pattern 306 may have high-field intensity in an upward direction. The first radiation pattern 304 and the second radiation pattern 306 are taken at one frequency, one polarization, and one plane cut. The first radiation pattern 304 and the second radiation pattern 306 are generally presented in polar or rectilinear form with a Decibel (dB) strength scale. The first radiation pattern 304 and the second radiation pattern 306 are normalized to the maximum graph value, 0 dB, and directivity is given for the first antenna pair 204 and the second antenna pair 206.

The present disclosure achieves antenna diversity between the first antenna pair 204 and the second antenna pair 206 to eliminate electromagnetic signal fading. Antenna diversity is a transmission technique in which the information carrying signal is transmitted along different propagation paths. Antenna diversity can be achieved by selecting a radiation pattern of an antenna, such that the antenna transreceives the best quality signal. This can be achieved by switching between antennas to select a best radiation pattern. Further, antenna diversity can be achieved by combining the radiation patterns of a plurality of antennas. Various diversity schemes, such as space, polarization, angle, frequency and time diversity, can be achieved by making structural and angular changes in the first antenna pair 204 and the second antenna pair 206 of the present disclosure. The first antenna pair 204 and the second antenna pair 206 are kept sufficiently far apart so that the multipath components of the electromagnetic signals have significantly different propagation paths.

Further, the distance between the first antenna pair 204 and the second antenna pair 206 is made large enough to ensure independent electromagnetic signal fading. For another embodiment, the separation of at least half of the wavelength of the electromagnetic signal to be received is required to obtain two uncorrelated signals in the eyewear 200. Such an arrangement is known as space diversity, which enables the eyewear 200 to operate with the best quality signal, which has minimal noise and interference. For another embodiment, the electromagnetic signals may arrive at the first antenna pair 204 and the second antenna pair 206 via several paths, each with a different angle of arrival. Moreover, the electromagnetic signal component can be isolated into different angular components. Furthermore, the present disclosure enables the electromagnetic signal received from different antenna pairs pointing at different angles to be uncorrelated. Such an arrangement is known as angle diversity. Angle diversity in the eyewear 200 can be achieved by changing the structural angle between the first antenna pair 204 and the second antenna pair 206, which are coupled together by the isolation bridge 202. For another embodiment, the present disclosure can enable time diversity in the eyewear 200 to send the same data over a channel at different time slots. Time diversity can be achieved by the eyewear 200 if time separations are large enough between transreceiving electromagnetic signals. The required time separation is at least as great as the reciprocal of the fading electromagnetic signal's bandwidth.

Isolation bridge 202 provides electromagnetic isolation between the first radiation pattern 304 and the second radiation pattern 306, for achieving antenna diversity. Isolation bridge 202 provides desired structural distance and angle between the first antenna pair 204 and the second antenna pair 206 for the desired antenna diversity scheme. Further, electromagnetic isolation between the first radiation pattern 304 and the second radiation pattern 306 is provided by physical distance, attained due to the structural formation of the eyewear 200. Furthermore, a user of the eyewear 200 can provide isolation between the first radiation pattern 304 and the second radiation pattern 306 by wearing the eyewear 200 on his or her head. The extent of isolation between the first radiation pattern 304 and the second radiation pattern 306 can be measured in terms of the diversity correlation coefficient. The diversity correlation coefficient is a relative measure of the field interference between the first radiation pattern 304 and the second radiation pattern 306. The present disclosure achieves a diversity correlation coefficient in the range of below one unit. A diversity correlation coefficient of the range below one unit is desirable for achieving sufficient isolation between the first radiation pattern 304 and the second radiation pattern 306, for achieving diversity. Further, the isolation between the radiation pattern 304 and the radiation pattern 306 can vary at different electromagnetic signal frequencies. The present disclosure can achieve high isolation between the first radiation pattern 304 and the second radiation pattern 306 at multiple frequency values. Moreover, the present disclosure includes selecting material for the first antenna pair 204 and the second antenna pair 206, which will result in low-return losses. Return loss in an antenna is the difference between the power input to and the power reflected from a discontinuity in the antenna circuit. Return loss is often expressed as the ratio in the decibels of the power incident on the antenna to the power reflected from the antenna at a particular frequency or band of frequencies.

Further, the present disclosure is directed toward operating multiple applications simultaneously. Examples of applications can be a GPS system, Bluetooth, a Wi-Fi network application, a DVB system, a radio frequency identification (RFID) system, etc. The present disclosure enables the user of the eyewear 200 to tune the first antenna pair 204, for transreceiving electromagnetic signals for a first application. Further, the user can tune the second antenna pair 206 for transreceiving electromagnetic signals for a second application. For an embodiment, the user can tune the first antenna pair 204 and the second antenna pair 206 simultaneously. The user can tune the first antenna pair 204 for transreceiving electromagnetic signals for the first application. Furthermore, the user can tune the second antenna pair 206 for the second application. For another embodiment, the user can select at least one application, which can be operated by tuning at least one of the first antenna pair 204 and the second antenna pair 206.

For another embodiment, the eyewear 200 can include a plurality of adjustable segments to form antenna pairs. A first adjustable segment with the eyepiece holder 208 can form a first antenna pair 204 for transreceiving electromagnetic signals. A second adjustable segment with the eyepiece holder 210 can form a second antenna pair 206 for transreceiving electromagnetic signals. For another embodiment, there can be any combination of the first adjustable segment and the second adjustable segment with the eyepiece holders 208 and 210 for transreceiving electromagnetic signals.

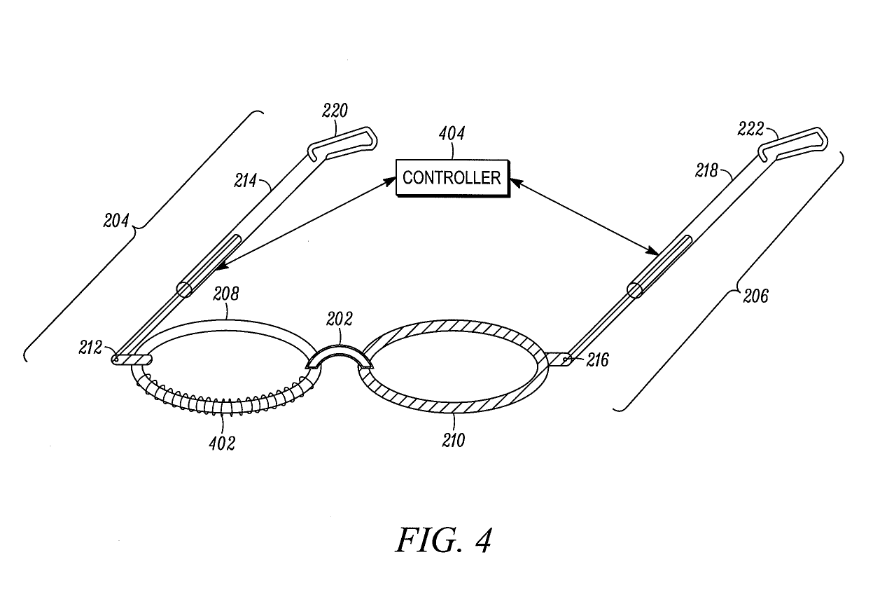

FIG. 4 is a functional diagram illustrating the operation of the eyewear 200, in accordance with some embodiments of the present disclosure. The eyewear 200 includes the isolation bridge 202, to provide electromagnetic isolation between the first antenna pair 204 and the second antenna pair 206. The first antenna pair 204 is formed by the eyepiece holder 208 with the adjustable antenna frames 212 and 214. The integrated circuitry 220 controls the first antenna pair 204 for transreceiving electromagnetic signals. The second antenna pair 206 is formed by the eyepiece holder 210 with the antenna frames 216 and 218. The integrated circuitry 222 controls the second antenna pair 206 for transreceiving the electromagnetic signals. For another embodiment, the eyepiece holders 208 and 210 can include multiple application antennas. The eyepiece holders 208 and 210 can be segmented or meandered for transreceiving multiple electromagnetic signals. For an embodiment, the eyepiece holder 208 can be meandered by using a coil 402 wrapped around the eyepiece holder 208. The coil 402, for example, enables the first antenna pair 204 to receive DVB electromagnetic signals. A controller 404 controls the functioning of the eyewear 200. Examples of a controller can include a personal digital assistant (PDA), a laptop computer, a microprocessor, etc. For another embodiment, the controller 404 can be embedded in the eyewear 200. For yet another embodiment, the eyewear 404 can have a plurality of controllers. For another embodiment, a printed circuit in the shape of eyepiece holder 208 can act in place of the coil 402 for receiving DVB electromagnetic signals.

The controller 404 can transreceive electromagnetic signals with the eyewear 200. The eyewear 200 communicates with the controller 404 through the first antenna pair 204 and the second antenna pair 206. For an embodiment, the controller 404 can receive information about the first radiation pattern 304 and the second radiation pattern 306 from the eyewear 200. The controller 404 can process the information about the first radiation pattern 304 and the second radiation pattern 306 and select the antenna pair that has the best quality radiation pattern. Further, the controller 404 can assign the selected antenna as a primary antenna pair. Moreover, the controller 404 can instruct the eyewear 200 to use the radiation pattern of the primary antenna pair. In the event of a change in the radiation pattern 304 and the radiation pattern 306, the controller 404 can reassign one of the antenna pair as the primary antenna pair. For an embodiment, the controller assigns at least one of the first antenna pair 204 and the second antenna pair 206 as the primary antenna pair. Further, the controller 404 can combine the first radiation pattern 304 and the second radiation pattern 306, for eliminating the electromagnetic signal fading and achieving diversity.

The controller 404 enables a user of the eyewear 200 to select multiple application operations simultaneously. The user can select a first application, to be executed by using the second antenna pair 206. The controller 404 directs the integrated circuitry 222 for receiving electromagnetic signals corresponding to the first application. The integrated circuitry 222 starts transreceiving electromagnetic signals corresponding to the first application through the second antenna pair 206. An interface module of the integrated circuitry 222 interprets the electromagnetic signals for executing the first application. For an embodiment, the user can select any combination of application operations with any combination of the first antenna pair 204 and the second antenna pair 206. For another embodiment, the controller 404 can select any combination of application operations with any combination of the first antenna pair 204 and the second antenna pair 206.

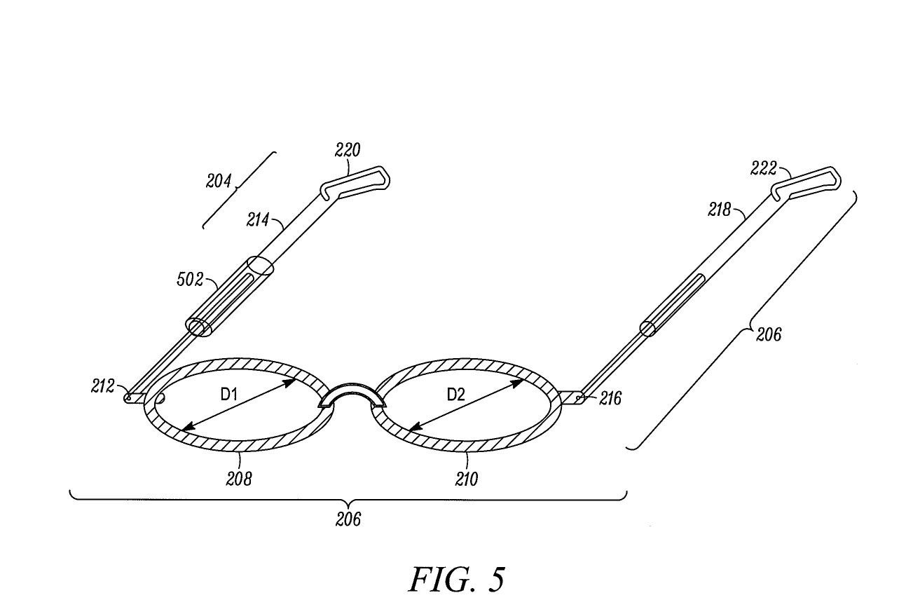

FIG. 5 illustrates a functional diagram of the eyewear 200, in accordance with an embodiment of the present disclosure. The first antenna pair 204 is formed by the eyepiece holder 208 with the adjustable antenna frames 212 and 214. The integrated circuitry 220 controls the first antenna pair 204 for transreceiving electromagnetic signals. The second antenna pair 206 is formed by the eyepiece holder 210 with the antenna frames 216 and 218. The integrated circuitry 222 controls the second antenna pair 206 for transreceiving the electromagnetic signals. Further, the eyewear 200 includes an isolator 502. The isolator 502 provides electromagnetic isolation between the first antenna pair 204 and the second antenna pair 206. The isolator 502 can be placed at various positions in the eyewear 200 so as to provide isolation between the two antenna pairs. The isolator 502 can separate the two antenna pairs in a number of ways. For example, the isolator 502 can be placed between the adjustable antenna frame 212 and adjustable antenna frame 214. Hence, the isolator 502 provides two antenna pairs, the first antenna pair 204 including the integrated circuitry 220 and the adjustable antenna frame 214 and the second antenna pair 206 as combination of adjustable antenna frame 212, the eye-piece holder 208, the eye-piece holder 210, the adjustable antenna frame 216, the adjustable antenna frame 218 and the integrated circuitry 222. Similarly, the isolator 502 can be placed at various positions in the eye-wear 200 to provide multiple different antenna pairs. Further, it should be appreciated that the combination of antenna pairs have been shown for exemplary purposes and should not be construed to restrict the scope of the present disclosure in any way.

The present disclosure is directed at providing a system for transreceiving electromagnetic signals in a wireless communication network. The communication network includes a plurality of transreceiving data-processing units which can transreceive electromagnetic signals by using a remote data-processing unit. The remote data-processing unit is an eyewear, which incorporates antenna pairs with integrated circuitries embedded in the eyewear frame, to enable transreceiving of electromagnetic signals. The eyewear enables multiple or single-application operations simultaneously. Examples of applications can be the Internet, television, GPS, Bluetooth, DVB-H, WiFi, XM radio, etc. Furthermore, the eyewear achieves diversity between the antenna pairs, to reduce electromagnetic signal fading, providing high quality electromagnetic signal transmission. Moreover, the eyewear integrates multiple operation modules without using wired communication links, to improve mobility and user interface.

It will be appreciated that the system for transreceiving electromagnetic signals in a communication network described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method to enable users to view a broadcasted media stream differently. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. An apparatus comprising:
a first eyeglass frame section;
a first antenna embedded in the first eyeglass frame section;
a second eyeglass frame section; and
a second antenna embedded in the second eyeglass frame section.

2. The apparatus as recited in claim 1 further comprising an isolator coupled between the first antenna and the second antenna for diversity between the first antenna and the second antenna.

3. The apparatus as recited in claim 2 further comprising an eyeglass frame bridge.

4. The apparatus as recited in claim 1, wherein the first eyeglass frame section comprises:
a first frame temple;
a first eyepiece coupled to the first frame temple;
wherein the apparatus further comprises:
a bridge coupled to the first eyepiece; and
wherein the second eyeglass frame section comprises:
a second eyepiece coupled to a substantially opposite side of the bridge from the first eyepiece; and
a second frame temple coupled to the second eyepiece.

5. The apparatus as recited in claim 1, further comprising at least one controller configured to receive information from at least one of the first antenna and the second antenna, wherein the at least one controller is further configured to change a radiation pattern of the at least one of the first antenna and the second antenna based on received information.

6. The apparatus as recited in claim 5, wherein the at least one controller is further configured to select a radiation pattern from the radiation pattern of the at least one of the first antenna and the second antenna for eliminating electromagnetic signal fading.

7. The apparatus as recited in claim 1, wherein the first antenna comprises:
a first adjustable segment configured to receive electromagnetic signals; and
wherein the second antenna comprises:
a second adjustable segment configured to receive electromagnetic signals.

8. The apparatus as recited in claim 1 further comprising at least one integrated circuitry coupled to at least one of the first antenna and the second antenna.

9. An apparatus for transreceiving electromagnetic signals, the apparatus comprising:
an eyeglass frame section;
a first antenna embedded in the eyeglass frame section for transreceiving electromagnetic signals;
a bridge coupled to the eyeglass frame section; and
a second antenna embedded in the eyeglass frame section for transreceiving electromagnetic signals.

10. The apparatus as recited in claim 9, wherein the eyeglass frame section comprises a first eyeglass frame section and a second eyeglass frame section.

11. The apparatus as recited in claim 9, wherein the bridge comprises an isolator coupled between the first antenna and the second antenna for diversity between the first antenna and the second antenna.

12. The apparatus as recited in claim 9, wherein the eyeglass frame section comprises:
a first frame temple;
a first eyepiece coupled to the first frame temple, wherein the bridge is coupled to the first eyepiece;
a second eyepiece coupled to a substantially opposite side of the bridge from the first eyepiece; and
a second frame temple coupled to the second eyepiece.

13. The apparatus as recited in claim 9, further comprising at least one controller configured to receive information from at least one of the first antenna and the second antenna, wherein the at least one controller is further configured to change a radiation pattern of the at least one of the first antenna and the second antenna based on received information.

14. The apparatus as recited in claim 13, wherein the at least one controller is further configured to select a radiation pattern from the radiation pattern of the at least one of the first antenna and the second antenna for eliminating electromagnetic signal fading.

15. The apparatus as recited in claim 9, wherein the first antenna comprises:
a first adjustable segment configured to receive electromagnetic signals; and
wherein the second antenna comprises:
a second adjustable segment configured to receive electromagnetic signals.

16. The apparatus as recited in claim 9 further comprising at least one integrated circuitry coupled to at least one of the first antenna and the second antenna.

17. An apparatus for diversity, the apparatus comprising:
a first eyeglass frame section;
a first antenna embedded in the first eyeglass frame section;
a second eyeglass frame section;
a second antenna embedded in the second eyeglass frame section; and
a bridge coupled between the first eyeglass frame section and the second eyeglass frame section, wherein the bridge comprises an isolator for diversity between the first antenna and the second antenna.

18. The apparatus as recited in claim 17, wherein the first eyeglass frame section comprises:
a first frame temple;
a first eyepiece coupled to the first frame temple; and
wherein the second eyeglass frame section comprises:
a second eyepiece coupled to a substantially opposite side of the bridge from the first eyepiece; and
a second frame temple coupled to the second eyepiece.

19. The apparatus as recited in claim 17, further comprising at least one controller configured to receive information from at least one of the first antenna and the second antenna, wherein the at least one controller is further configured to change a radiation pattern of the at least one of the first antenna and the second antenna based on received information.

20. The apparatus as recited in claim 19, wherein the at least one controller is further configured to select a radiation pattern from the radiation pattern of the at least one of the first antenna and the second antenna for eliminating electromagnetic signal fading.

21. The apparatus as recited in claim 17, wherein the first antenna comprises:
a first adjustable segment configured to receive electromagnetic signals; and
wherein the second antenna comprises:
a second adjustable segment configured to receive electromagnetic signals.

22. The apparatus as recited in claim 17 further comprising at least one integrated circuitry coupled to at least one of the first antenna and the second antenna.
